(19) United States
(12) Patent Application Publication
(10) Pub. No.: US 2020/0241103 A1
(43) Pub. Date: Jul. 30, 2020

(54) ACCESS MAT TRACKING AND COMMUNICATION SYSTEM

(71) Applicants: Daniel George Vernon, Ashland, WI (US); Brian Carl Gustafson, Roosevelt, MN (US); Matthew Todd Freudenrich, Fort Ripley, MN (US)

(72) Inventors: Daniel George Vernon, Ashland, WI (US); Brian Carl Gustafson, Roosevelt, MN (US); Matthew Todd Freudenrich, Fort Ripley, MN (US)

(73) Assignee: Northern Clearing, Inc., Ashland, WI (US)

(21) Appl. No.: 16/749,480

(22) Filed: Jan. 22, 2020

Related U.S. Application Data
(60) Provisional application No. 62/796,434, filed on Jan. 24, 2019.

(51) Int. Cl. G01S 1/04; G01S 1/68; E01C 9/08

(52) U.S. Cl. CPC G01S 1/0423; E01C 9/086; G01S 1/68

(57) ABSTRACT

A beacon for an access mat used to support heavy equipment. The beacon includes electronic circuitry configured to wirelessly transmit signals containing access mat data. A housing IS configured to house the electronic circuitry within a sealed enclosure. The housing is also configured to be removably installed in some portion of the access mat. The housing may be hermetically sealed, and may further be constructed to resist shock, vibration, moisture and extreme temperatures.

### CROSS-REFERENCE TO RELATED PATENT APPLICATION

This patent application claims the benefit of U.S. Provisional Patent Application No. 62/796,434, filed Jan. 24, 2019, the entire teachings and disclosure of which are incorporated herein by reference thereto.

### FIELD OF THE INVENTION

This invention generally relates to systems for tracking and managing access mats.

### BACKGROUND OF THE INVENTION

Access mats are portable platforms used to support heavy equipment used in construction, maintenance and other similar activities, including on drilling rigs, logging operations, portable storage tanks, and the like. Access mats are often used in the building and construction industry to create a surface on which heavy construction equipment can travel and operate. Access mats may also be used as structural roadways to provide passage over unstable ground.

Access mats are typically used on wet, grassy, rocky, or unstable surfaces which could damage or severely hinder operation of the aforementioned construction equipment. More specifically, these access mats can be used to create temporary roadways and bridges so that there is a stable platform surface on which the construction equipment can be positioned to perform the task for which it is designed. Thus, in addition to protecting the construction equipment, access mats protect the environment in which construction or maintenance activities occur from damage which the equipment would cause without the access mats, and allow for more efficient operation of the construction equipment.

Access mats may represent a large financial expenditure for certain construction and maintenance projects, and effective management of these mats can provide substantial cost savings to a project. Typically, contractors have relied on truck drivers to provide information on the location and condition of access mats whenever they deliver or move them to an area on a project. Due to human error, or the mats moving additional times along the project corridor or right-of-way, and due to failure to properly communicate that movement, accurate management of access mat inventory and location is difficult. Additionally, understanding the age of all access mats in a company's inventory has been difficult to achieve. It would be desirable to have a system that would allow companies to know the date in which their access mats were put into service.

Embodiments of the invention provide a better way for access mat suppliers to track and manage access mats. These and other advantages of the invention, as well as additional inventive features, will be apparent from the description of the invention provided herein.

### BRIEF SUMMARY OF THE INVENTION

In one aspect, embodiments of the invention provide a beacon for an access mat used to support heavy equipment. The beacon includes electronic circuitry configured to wirelessly transmit signals containing access mat data. A housing is configured to house the electronic circuitry within a sealed enclosure. The housing is also configured to be removably installed in some portion of the access mat.

In a particular embodiment, the electronic circuitry includes a communications module configured to wirelessly transmit and receive signals. The communications module may communicate wirelessly using the Bluetooth communications protocol, though other communications protocols including, but not limited to LTE, RF, Z-Wave, Wi-Fi, and Zigbee, are envisioned. In some embodiments, the beacon, or more specifically the electronic circuitry within the beacon, is configured to be activated via a command from a mobile electronic device. In more particular embodiments, following activation, the electronic circuitry is configured to cause the communications module to periodically transmit the access mat data. In other more particular embodiments, the electronic circuitry is configured to be activated when the mobile electronic device scans a QR code for the beacon or when the user manually inputs a serial number of the beacon using an application downloaded onto the mobile electronic device. The access mat data could be received by any nearby mobile gateway device or by a mobile electronic device having a downloadable application to allow wireless communication with the beacon.

Furthermore, the electronic circuitry may also include an accelerometer module to detect movement of the beacon. In some embodiments, the electronic circuitry is configured to decrease the time between successive transmissions of access mat data when the accelerometer module detects movement of the beacon. In a further embodiment, the electronic circuitry is configured for two-way communication with a mobile gateway device configured to store and transmit, via cellular or Wi-Fi connection, the access mat data received from the communications module.

In certain embodiments of the invention, the beacon also includes a battery disposed within the housing. Additionally, the housing may be hermetically sealed. In particular embodiments, the beacon includes a potting compound within the housing and surrounding at least some portion of the electronic circuitry in order to make the beacon, water and dust proof, resistant to extreme temperature, as well as resistant to vibration and physical shocks. In a more particular embodiment, the housing is cylindrical. Further embodiments include those where the housing is less than three inches in diameter, though in other embodiments, the housing is less than two inches in diameter. The height of the housing is less than two inches in some embodiments, and less than one inch in other embodiments.

Embodiments of the beacon include a housing with two openings to accommodate mechanical fasteners. The housing may be made from plastic though other similarly suitable materials are also envisioned.

In another aspect, embodiments of the invention provide an access mat tracking and communication system that includes a beacon configured to wirelessly transmit signals containing access mat data. The beacon is disposed within a hermetically-sealed housing, and the housing is designed to be removably installed in some portion of an access mat. A networked server is configured to receive and store access mat data transmitted by the beacon, and further configured to provide location data for the access mat via a user interface viewable on a user device.

In a particular embodiment, the beacon includes a battery and is configured for two-way communication with a mobile gateway device or a mobile electronic device. The beacon may be further configured to wirelessly transmit the access mat data to the mobile gateway device or the mobile electronic device, which then uploads the access mat data to the networked server.

In some embodiments, the housing is cylindrical, less than two inches in diameter, and with a height less than one inch. Furthermore, the housing may include two openings to accommodate mechanical fasteners, and further, the housing may be made from plastic. Further still, the beacon may include a potting compound surrounding at least some portion of the electronic circuitry within the housing in order to make the beacon vibration and shock resistant, and to provide resistance to extreme temperatures and moisture.

In a further embodiment, the beacon includes electronic circuitry with a communications module configured to wirelessly transmit and receive signals, and an accelerometer module to detect movement of the beacon. The electronic circuitry is configured to cause the communications module to increase the frequency of access mat data transmissions when the accelerometer module detects movement of the beacon. Also, the networked server may include a downloadable application for distribution to the user device. In certain embodiments, the downloadable application allows the user device to communicate with the beacon or a mobile gateway device that communicates with the beacon. In this manner, the user device, in some instances, may upload access mat data to the networked server. The user device may be one of a smart phone, a smart watch, a tablet computer, a laptop computer, and a personal computer.

In particular embodiments, the networked server is configured to show, on a display of the user device, the locations for a plurality of beacons. The display may show multiple beacon locations on a map, for example, though other ways of providing location data are envisioned. Alternatively, location data, along with battery status and signal strength information, for example, may be shown in a table or spreadsheet. The location data could be provided by latitude and longitude, or by location name, e.g., project, city, state, county, etc.). In certain embodiments, the location data includes altitude.

In some embodiments, the access mat data includes, but is not limited to, a status of the battery in the beacon, accelerometer activity, and a signal strength of the wirelessly transmitted signal in addition to the aforementioned access mat location data. To provide the aforementioned location data, the beacon may be configured to receive and transmit GPS data. In some embodiments, the mobile gateway device 106 is configured to receive and transmit GPS data, and determines a GPS location for a beacon 102 after receiving the beacon's transmission. The beacon may be equipped with an audible function to facilitate rapid location of the beacon.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic diagram of an access mat communication system, constructed in accordance with an embodiment of the invention;

FIG. 2 is a perspective view of an open housing for a beacon, in accordance with an embodiment of the invention;

FIG. 3 is another perspective view of the housing for the beacon, according to an embodiment of the invention; and

FIG. 4 is a perspective view of the electronic circuitry and battery for the beacon, according to an embodiment of the invention; and

FIG. 5 is a schematic illustration of the electronic circuitry for the beacon, according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

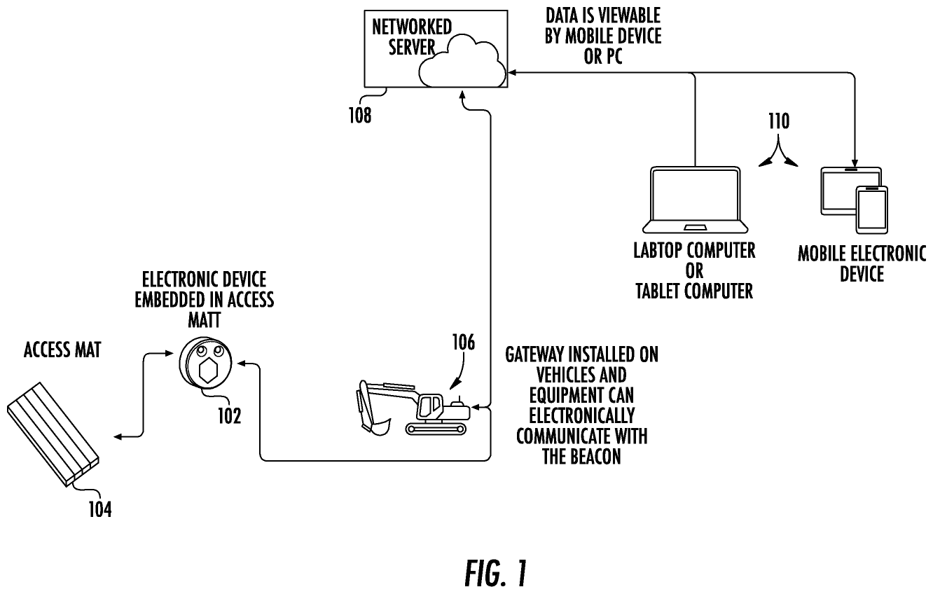

As provided in a particular embodiment of the invention shown in FIG. 1, an access mat tracking and communication system 100 includes a beacon 102 that is installed in one of the timbers or composite members of an access mat 104. In a more particular embodiment, the beacon 102 is sealed with an enclosure, is vibration resistant and designed to withstand extreme weather environments. The beacon 102 and enclosure would also be designed to withstand the strains and impacts endured by access mats from transport, installation, and use involving large construction vehicles, such as dump trucks, cranes, back hoes, bulldozers, delivery vehicles, etc.

The beacon 102 in FIG. 1 may be battery operated, with a battery life of up to 5 years or more even in extreme temperature environments. Embodiments of the beacon 102 are designed to communicate wirelessly over a distance of up to 150 meters or more. The beacon 102 is designed such that a number of different communications protocols may be used for this wireless communication including, but not limited to, Bluetooth, LTE, RF, Z-Wave, Wi-Fi, and Zigbee. Furthermore, specific embodiments of the beacon 102 are designed with the ability to assign a unique identifier (i.e., mat type, mat dimensions, mat supplier, in-service date, identification number, etc.) to each access mat.

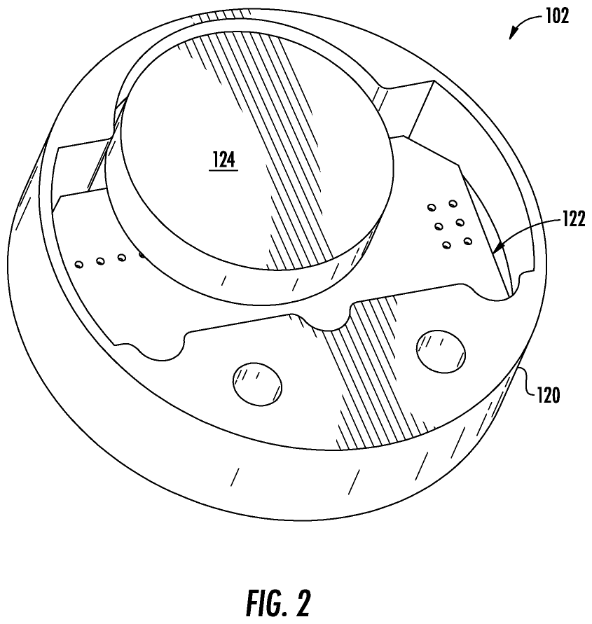

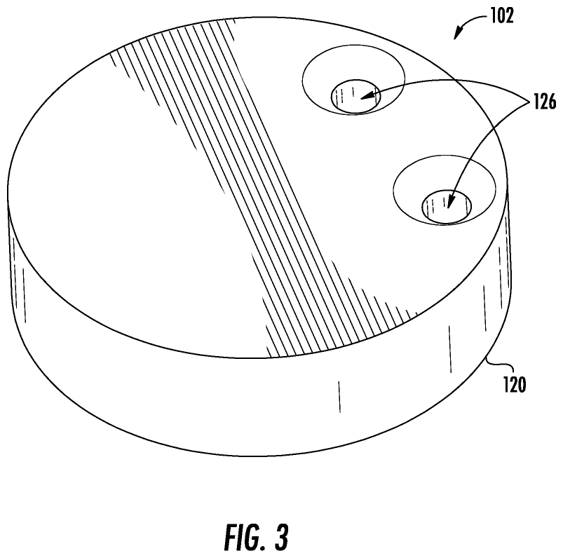

FIG. 1 provides a schematic example of an access mat tracking and communication system 100, constructed in accordance with an embodiment of the invention. As stated above, the access mat tracking and communication system 100 includes a beacon 102 which is embedded within some portion of an access mat 104. The beacon 102 is configured to wirelessly transmit signals containing access mat data, and may be configured to receive wireless transmissions as well. In certain embodiments, the beacon 102 is disposed within a hermetically-sealed housing 120 (see FIGS. 2 and 3), and the housing 120 is designed to be removably installed in some portion of an access mat 104.

The beacon 102 is designed to communicate with a mobile gateway device 106 installed in a vehicle, on a building, on a tower or pole, on a piece of heavy equipment, or other stationary object. Access mat data, gathered by the mobile gateway device 106 from the beacon 102, is stored and then uploaded to a networked server 108, which may be a cloud server or a private server. The networked server 108 is configured to receive and store the access mat data transmitted by the beacon 102, and also configured to provide location data for the access mat 104 via a user interface viewable on a user device 110. The uploaded access data is stored on the networked server 108 and may be viewed on command by a user on the user device 110.

The collected access mat data could be viewed on the mobile electronic device 110 or on any other user device 110 (e.g., a personal computer such as a laptop, notebook, or desktop computer) capable of communicating with the networked server 108. In a particular embodiment, the networked server 108 is configured to provide a user interface for computers and mobile electronic devices 110 with the ability to upload a GIS or similar mapping file to provide a map overlay of the beacons 102 in a selected region. In some embodiments, the interface includes a map view of beacon/access mat locations, along with the ability to select beacons 102 populating a display window on the user device 110 that provide details such as asset identification, the date and/or time of the last connection, the battery status at the last connection, date of access mat placement or removal, the ability to highlight an “area” on the map which provides a summary of all beacons 102 in that area. In particular embodiments, the user interface provides an exportable CSV and/or PDF file of the aforementioned details.

In a particular embodiment, the networked server 110 includes a downloadable application for distribution, via a network such as the internet, to the user device 110. The downloadable application may be configured so that it operates in the background of the user device 110. In certain embodiments, the downloadable application allows the user device 110 to communicate with the beacon 102 or the mobile gateway device 106, which communicates with the beacon 102. In this manner, the user device 110, in some instances, may also upload access mat data to the networked server 108. The user device 110 may be one of a smart phone, a smart watch, a tablet computer, a laptop computer, and a personal computer, and, in some instances, is referred to below as a mobile electronic device 110

The downloadable application also facilitates activation of the beacon 102. In at least one embodiment, the mobile electronic device 110 with the downloadable application scans a QR code on the beacon 102 or associated with the beacon 102 in order to activate the beacon 102. The beacon 102 may also be activated when the user inputs the beacon serial number using the downloadable application. Following activation, the beacon 102 may be configured to periodically transmit the access mat data. This access mat data transmission could be received by any nearby mobile gateway device 106 or by a nearby mobile electronic device 110 having the downloadable application to allow wireless communication with the beacon 102.

In particular embodiments, after the beacon 102 is activated via the downloadable application, the mobile electronic device 110 with the downloadable application can be used to assign the access mat details such as supplier, make, model, dimensions, mat size, mat type, etc.). The downloadable application also allows users to see their location in relation to where the beacon 102 is located. When the mobile electronic device 110 with the downloadable application is within range of the beacon transmission, the user can pair with the beacon. This pairing may allow the user to perform one or more of the following actions: activate the audible function, deactivate the beacon, or reassign the beacon to a different asset. However, it should be noted that the user is not limited to these particular actions, as the downloadable application may be designed to include additional features.

It is also envisioned that embodiments of the downloadable application have the capability to track and store dates, such as date of connection, time of connection, etc. The downloadable application may include a map overlay (e.g., on a satellite imagery map) for tracking a user's location and the location of known beacons 102. In certain embodiments, if there is no available cellular signal, the downloadable application is configured to use the current GPS location of the mobile electronic device 110. The map overlay may be interactive allowing the user to make certain changes or to add or remove map features.

In certain embodiments, the networked server 108 is configured to show, on a display of the user device 110, the locations for a plurality of beacons 102. The networked server 108 may also be configured to show, on the display of the user device 110, multiple beacon locations on a map, for example, though other ways of providing location data are envisioned. For example, location data along with battery status and signal strength information may be shown in a table or spreadsheet. The location data could be provided by latitude and longitude, or by location name, e.g., project, city, state, county, etc.). In certain embodiments, the location data also includes altitude.

In some embodiments, the access mat data includes, but is not limited to, a status of the battery in the beacon, accelerometer activity, and a signal strength of the wirelessly transmitted signal in addition to the aforementioned access mat location data. To provide the aforementioned location data, the beacon 102 may be configured to receive and transmit GPS data. In alternate embodiments, the mobile gateway device 106 is configured to receive and transmit GPS data, and determines a GPS location for a beacon 102 after receiving the beacon's transmission.

In some embodiments, the access mat data includes, but is not limited to, a status of the battery in the beacon 102, accelerometer activity, and a signal strength of the wirelessly transmitted signal in addition to the aforementioned access mat location data. The beacon 102 may be equipped with an audible function to facilitate rapid location of the beacon 102.

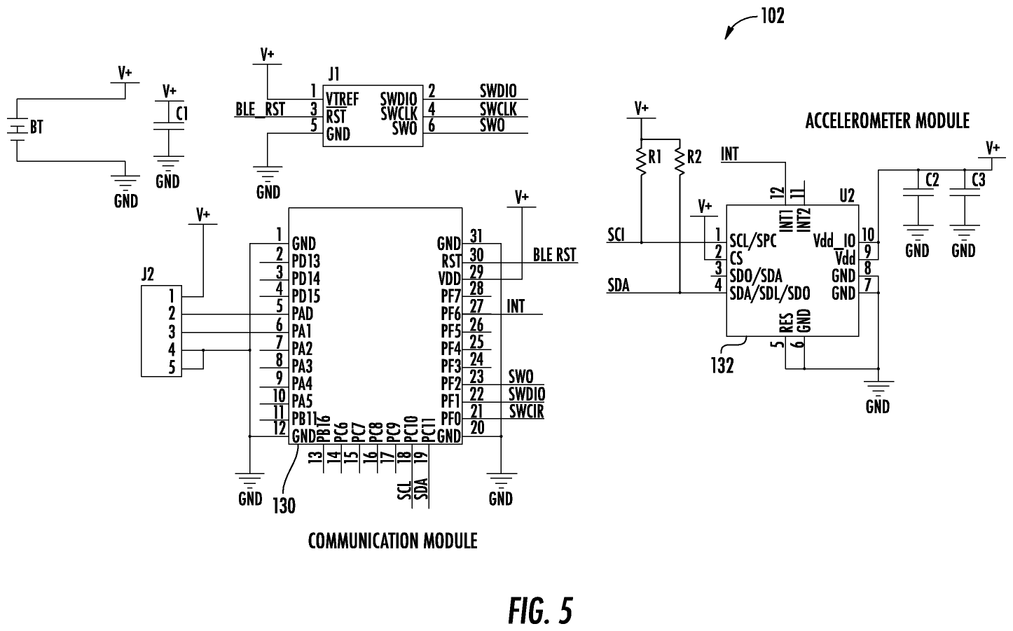

FIGS. 2 and 3 provide two different perspective views of the housing 120 for the beacon 102. FIG. 2 shows an open housing 120 in which electronic circuitry 122 and a battery 124 for the beacon 102 are shown disposed within the housing 120. In a particular embodiment, the beacon 102 includes the battery 124 and is configured for two-way communication with the mobile gateway device 106 or the mobile electronic device 110. The beacon 102 may be further configured to wirelessly transmit the access mat data to the mobile gateway device 106 or the mobile electronic device 110, which are configured to store access mat data received from the beacon's communications module 130 (shown in FIG. 5). The mobile gateway device 106 or the mobile electronic device 110 then uploads the access mat data to the networked server 108.

In some embodiments, the housing 120 is cylindrical, less than three inches in diameter, and with a height less than two inches. In more particular embodiments the cylindrical housing 120 is less than two inches in diameter with a height less than one inch. The cylindrical housing 120 is designed to fit securely with an opening formed or drilled in an access mat of any type, to include but not limited to laminate, timber or composite member. Furthermore, the housing 120 may include two openings 126 to accommodate mechanical fasteners, and further, the housing 120 may be made from plastic. Further still, the beacon 102 may include a potting compound surrounding at least some portion of the electronic circuitry 122 within the housing 120 in order to make the beacon 102 vibration- and shock-resistant, and to provide resistance to extreme temperatures and moisture.

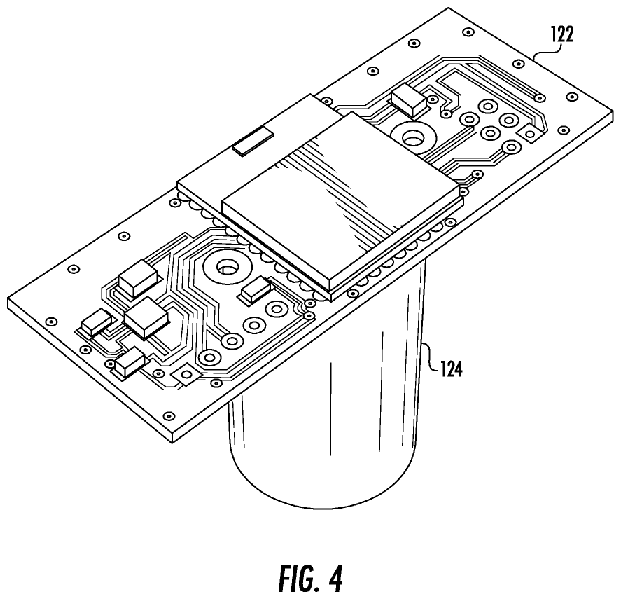

FIG. 4 is a perspective view of the electronic circuitry 122 and battery 124 for the beacon 102, according to an embodiment of the invention, while FIG. 5 is a schematic illustration of the electronic circuitry 122 for the beacon 102. In the embodiment of FIGS. 4 and 5, the beacon 102 includes electronic circuitry 122 with a communications module 130 configured to wirelessly transmit and receive signals, and an accelerometer module 132 to detect movement of the beacon 102. The height of the battery 124 as shown in FIG. 4 is exaggerated so as to make it easily visible in this figure.

As mentioned above, following activation of the beacon 102, or more specifically the electronic circuitry 122 in the beacon 102, the electronic circuitry 122 may be configured to cause the communications module 130 to periodically transmit the access mat data. In a particular embodiment, the electronic circuitry 122 is configured to cause the communications module 130 to increase the frequency of its access mat data transmissions when the accelerometer module 132 detects movement of the beacon so as to decrease the time between successive transmissions of access mat data. For example, the communications module 130 may be configure to transmit the access mat data once per hour when the beacon 102 is stationary.

However, if the accelerometer module 132 detects sustained movement of the beacon 102, the communications module 130 may then be commanded to transmit the access mat data once every five or ten minutes, or every 20 to 30 minutes depending on various factors that may include the remaining battery life for the beacon 102. Once the accelerometer module 132 determines that the beacon 102 is stationary, the access mat data transmissions can go back to their normal transmission rate of once per hour or less frequently if the remaining battery life warrants.

The beacon 102 may be equipped with an audible function to facilitate rapid location of the beacon 102. This audible function may be activated by a user having a mobile electronic device 110 with the aforementioned downloadable application. A GPS device, installed in the beacon 102, may provide for the acquisition of the access mat location. However, in certain embodiments, a GPS device is installed in the mobile gateway device 106, and determines a GPS location for a beacon 102 after receiving a wireless transmission from the beacon 102.

As with the beacon 102, the mobile gateway device 106 is designed to reliably function in extreme weather conditions, and therefore may be housed in a weather-proof, shock and impact-resistant enclosure. The mobile gateway device 106 would be configured, in certain embodiment, to acquire various types of electronic data from beacons 102 (i.e., location, battery life, ID, etc.). That data can be transferred to a mobile electronic device 110, or transmitted to the networked server 108. Depending upon the particular installation, the mobile gateway device 106 could be powered by a vehicle, or by the battery on some other type of construction equipment, or a local power source when mounted in a fixed location such as a building or pole. Alternatively, the mobile gateway device 106 could include its own long-lasting battery or solar powered system.

It should be noted that the system described herein is not limited to applications involving access mats 104, but could also be successfully deployed in the tracking and management of various construction related items such as, for example, data monitoring equipment, power generators, electrical transformers, cable installation systems, garbage dumpsters, portable bathrooms, and other types of construction equipment, tools, and materials.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A beacon for an access mat used to support heavy equipment, the beacon comprising:
electronic circuitry configured to wirelessly transmit signals containing access mat data;
a housing configured to house the electronic circuitry within a sealed enclosure, wherein the housing is configured to be removably installed in some portion of the access mat.

2. The beacon of claim 1, wherein the electronic circuitry includes a communications module configured to wirelessly transmit and receive signals.

3. The beacon of claim 2, wherein the communications module communicates wirelessly using at least one of the Bluetooth, LTE, RF, Z-Wave, Wi-Fi, and Zigbee communications protocols.

4. The beacon of claim 2, wherein the electronic circuitry is configured to be activated via a command from a mobile electronic device.

5. The beacon of claim 4, wherein, following activation, the electronic circuitry is configured to cause the communications module to periodically transmit the access mat data.

6. The beacon of claim 4, wherein the electronic circuitry is configured to be activated when the mobile electronic device scans a QR code for the beacon.

7. The beacon of claim 1, wherein the electronic circuitry includes an accelerometer module to detect movement of the beacon.

8. The beacon of claim 7, wherein the electronic circuitry is configured to decrease the time between successive transmissions of access mat data when the accelerometer module detects movement of the beacon.

9. The beacon of claim 1, wherein the electronic circuitry is configured for two-way communication with a mobile gateway device configured to store access mat data received from the communications module.

10. The beacon of claim 1, further comprising a battery disposed within the housing.

11. The beacon of claim 1, wherein the housing is hermetically sealed.

12. The beacon of claim 1, further comprising a potting compound surrounding at least some portion of the electronic circuitry within the housing.

13. The beacon of claim 1, wherein the housing is cylindrical.

14. The beacon of claim 13, wherein the housing is less than three inches in diameter.

15. The beacon of claim 13, wherein the housing is less than two inches in diameter.

16. The beacon of claim 13, wherein the height of the housing is less than two inches.

17. The beacon of claim 13, wherein the height of the housing is less than one inch.

18. The beacon of claim 1, wherein the housing is made from plastic and includes two openings to accommodate mechanical fasteners.

19. The beacon of claim 1, wherein the electronic circuitry is configured to receive and transmit GPS data.

20. An access mat tracking and communication system comprising:
a beacon configured to wirelessly transmit a signal containing access mat data, the beacon disposed within a hermetically-sealed housing, wherein the housing is designed to be removably installed in a some portion of the access mat;
a networked server configured to receive and store access mat data transmitted by the beacon, and further configured to provide location data for an access mat via a user interface viewable on a user device.

21. The access mat tracking and communication system of claim 19, wherein the beacon includes a battery and is configured for two-way communication with a mobile gateway device or a mobile electronic device, the beacon further configured to wirelessly transmit the access mat data to the mobile gateway device or the mobile electronic device which then uploads the access mat data to the networked server.

22. The access mat tracking and communication system of claim 19, wherein the housing is cylindrical, less than two inches in diameter, and with a height less than one inch.

23. The access mat tracking and communication system of claim 19, wherein the housing includes two openings to accommodate mechanical fasteners, and is made from plastic.

24. The access mat tracking and communication system of claim 19, further comprising a potting compound disposed within the housing and surrounding at least some portion of the electronic circuitry.

25. The access mat tracking and communication system of claim 19, wherein the beacon includes electronic circuitry with a communications module configured to wirelessly transmit and receive signals, and an accelerometer module to detect movement of the beacon.

26. The access mat tracking and communication system of claim 25, wherein the electronic circuitry is configured to cause the communications module to increase the frequency of access mat data transmissions when the accelerometer module detects movement of the beacon.

27. The access mat tracking and communication system of claim 19, wherein the networked server includes a downloadable application for distribution to the user device, the downloadable application allowing the user device to communicate with the beacon or with a mobile gateway device that communicates with the beacon.

28. The access mat tracking and communication system of claim 19, wherein the networked server is configured to show, on a display of the user device, the locations of multiple beacons.

29. The access mat tracking and communication system of claim 19, wherein the access mat data includes one of a status of a battery in the beacon, accelerometer activity, and a signal strength of the wirelessly transmitted signal.

30. The access mat tracking and communication system of claim 19, wherein the user device is one of a smart phone, a smart watch, a tablet computer, a laptop computer, and a personal computer.
